(19) United States
(12) Patent Application Publication
(10) Pub. No.: US 2026/0143444 A1
(43) Pub. Date: May 21, 2026

(54) USER EQUIPMENT ASSOCIATION WITH A NETWORK

(71) Applicant: Lenovo (Singapore) Pte. Limited, Singapore (SG)

(72) Inventors: Roozbeh Atarius, La Jolla, CA (US); Genadi Velev, Darmstadt (DE)

(73) Assignee: Lenovo (Singapore) Pte. Limited, Singapore (SG)

(21) Appl. No.: 19/110,309

(22) PCT Filed: Sep. 25, 2023
(86) PCT No.: PCT/IB2023/059469

§ 371 Date: Mar. 10, 2025

Related U.S. Application Data
(60) Provisional application No. 63/409,968, filed on Sep. 26, 2022.

(51) Int. Cl. H04W 60/04; H04L 67/02; H04W 48/16; H04W 48/18

(52) U.S. Cl. CPC H04W 60/04; H04L 67/02; H04W 48/16; H04W 48/18

(57) ABSTRACT

Various aspects of the present disclosure relate to methods, apparatuses, and systems that support user equipment (UE) association with a network. For instance, implementations provide ways for UE registration requests and UE policy provisioning to be processed by a network. In implementations, payload containers of a registration request are processed separately by an access and mobility management function (AMF) and are transmitted to a policy control function (PCF) using two different hypertext transfer protocol (HTTP) POST request messages. The PCF implements a timer to ensure that both the HTTP POST messages are received by the PCF before the PCF initiates creating UE policy sections. In additional or alternative implementations, an AMF processes payload containers of a registration request into one payload. A PCF can then process new information identities and, in at least some implementations, identify and separate payload containers.

### RELATED APPLICATION

This application claims priority to U.S. Provisional Application Ser. No. 63/409,968 filed 26 Sep. 2022 entitled “USER EQUIPMENT ASSOCIATION WITH A NETWORK,” the disclosure of which is incorporated by reference herein in its entirety.

### TECHNICAL FIELD

The present disclosure relates to wireless communications, and more specifically to policy provisioning in wireless networks.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for a UE to register with a wireless network, such as to enable various policies to be applied for the UE communication within the wireless network. Current wireless communication systems, however, may not provide ways for policy provisioning where a UE is not already registered to a network.

### SUMMARY

The present disclosure relates to methods, apparatuses, and systems that support UE association with a network. For instance, implementations provide ways for UE registration requests and UE policy provisioning to be processed by a network. In implementations, payload containers of a registration request are processed separately by an access and mobility management function (AMF) and are transmitted to a policy control function (PCF) using two different hypertext transfer protocol (HTTP) POST request messages. The PCF implements a timer to ensure that both the HTTP POST messages are received by the PCF before the PCF initiates creating UE policy sections. In additional or alternative implementations, an AMF processes payload containers of a registration request into one payload. A PCF can then process new information identities and, in at least some implementations, identify and separate payload containers.

Accordingly, the described techniques provide efficient and accurate ways for UE registration and UE policy provisioning for wireless networks.

Some implementations of the methods and apparatuses described herein may further include receiving, at a first apparatus, a first request message to create an association, the first request including at least a first payload; initiating, based at least in part on the first request message, a timer; receiving a second request message to create the association, the second request message including at least a second payload not included in the first request message; stopping, based at least in part on the second request message, the timer; and establishing, based at least in part on the first request message and the second request message, the association.

Some implementations of the methods and apparatuses described herein may further include: where the first payload includes state information for a UE; the state information includes: one or more policy sections; support for access network discovery and selection policy (ANDSP); and optionally, one or more supported operating system identities (OS IDs); the second payload includes a request for policy provisioning for one or more services; further including: determining that the timer expires before receiving the second request message; and establishing the association based at least in part on the first request message; the association includes a UE policy association; to establish the UE policy association, one or more of: locating one or more predefined policy sections; retrieving one or more policy sections from a unified data repository (UDR) where the one or more policy sections are associated with the UE; or dynamically generating one or more policy sections.

Some implementations of the methods and apparatuses described herein may further include: where one or more of the first request message or the second request message includes an indicator of multiple requests and a number of requests, the indicator further indicating that the first request message and the second request message are configured for establishing the association; the first apparatus is associated with a PCF of a network, the first request and the second request are received from an AMF of the network, and further including establishing the association via interaction with a UDR of the network; further including receiving the first request message via a first HTTP POST request and receive the second request message as a second HTTP POST request.

Some implementations of the methods and apparatuses described herein may further include receiving a first request message to create an association, the first request message including at least a first payload; initiating, based at least in part on the first request message, a timer; stopping the timer; establishing, based at least in part on the first request message, a first association; receiving a second request message to create the association, the second request including at least a second payload not included in the first request; and establishing, based on both the first request message and the second request message, the association.

Some implementations of the methods and apparatuses described herein may further include: where the first payload includes state information for a UE; the state information includes: one or more policy sections; support for ANDSP; and optionally, one or more supported OS IDs; the second payload includes a request for policy provisioning for one or more services; the first association and the association include a UE policy association; one or more of the first request message or the second request message includes an indicator of multiple requests and a number of requests, the indicator further indicating that the first request message and the second request message are configured for establishing the association; to establish one or more of the first association or the association, one or more: locating one or more predefined policy sections; retrieving one or more policy sections from a UDR where the one or more policy sections are associated with a UE; or dynamically generating one or more policy sections; further including receiving the first request message via a first HTTP POST request and receive the second request message as a second HTTP POST request.

Some implementations of the methods and apparatuses described herein may further include receiving, at a first apparatus from a UE, a register message for creating an association, the register message including state information for the UE and a request for policy provisioning for one or more services for the UE; transmitting a request message including the state information and the request for policy provisioning; and implementing, based at least in part on the request message, a policy provisioning procedure to create the association.

Some implementations of the methods and apparatuses described herein may further include: where the state information for the UE includes: one or more policy sections; support for ANDSP; and optionally, one or more supported OS IDs; the first apparatus is associated with an AMF of a network, and wherein the method further includes transmitting the request message to a PCF of the network.

### BRIEF DESCRIPTION OF THE DRAWINGS

FIG. 1 illustrates an example of a wireless communications system that supports UE association with a network in accordance with aspects of the present disclosure.

FIGS. 2-6 illustrate example systems that support UE association with a network in accordance with aspects of the present disclosure.

FIG. 7 illustrates an example block diagram of devices that support UE association with a network in accordance with aspects of the present disclosure.

FIGS. 8 through 12 illustrate flowcharts of methods that support UE association with a network in accordance with aspects of the present disclosure.

### DETAILED DESCRIPTION

In wireless communications systems, a UE may perform a registration procedure to the 5GS and/or in single-registration mode, such as due to an inter-system change from S1 mode to N1 mode. During the registration procedure, the UE can initiate a UE-requested state indication procedure. The UE-requested state indication, for example, enables the UE to provide PCF the information about its UE Policy Section Identifier (UPSI) list, ANDSP support, and the identities of the operating systems (OS IDs) that the UE can support. Thus, if the UE is to receive policy provisioning for a service such as Vehicle-to-Everything Policy (V2XP) provisioning and/or 5G ProSe policy (ProSeP) provisioning at the time of performing registration, the UE-requested state indication procedure may not be able to provide this functionality. Current procedures for a UE to request policy provisioning for services such as V2X or ProSe are defined, however, when the UE has already successfully registered to the 5GS network.

One way to resolve such policy provisioning issues is for a UE to combine the UE-requested state indication procedure with the UE-requested policy provisioning procedure, including both the UE STATE INDICATION message and the UE POLICY PROVISIONING REQUEST message within the same REGISTER REQUEST message. However, under current implementations it is not clear how the network is to act upon receiving such a REGISTER REQUEST message.

Accordingly, this disclosure provides for techniques that support UE association with a network. For instance, implementations provide ways for UE registration requests and UE policy provisioning to be processed by a network. In implementations, payload containers of a registration request are processed separately by an AMF and are transmitted to a PCF using two different HTTP POST request messages. The PCF implements a timer to ensure that both the HTTP POST messages are received by the PCF before the PCF initiates creating UE policy sections, such as to account for scenarios where the PCF receives a policy request before a UE state indication message. The timer, for instance, is implemented as t seconds before the PCF initiates creating UE policy sections. For instance, if the UE does not receive a response message (e.g., command or rejection) for the policy provisioning request within e.g. 16 seconds, the UE can retransmit a new request for the policy provisioning.

In additional or alternative implementations, an AMF processes payload containers of a registration and provisioning request into one payload, e.g., where the related payload container types are the same. The PCF can then process the new information identities and, in addition, identify and separate the payload containers in case there is a need to response to e.g. policy provisioning so, the PCF can use correct procedure transaction identity (PTI) for the transmission.

Accordingly, the described techniques provide efficient and accurate ways for UE registration and UE policy provisioning for wireless networks.

Aspects of the present disclosure are described in the context of a wireless communications system. Aspects of the present disclosure are further illustrated and described with reference to device diagrams and flowcharts.

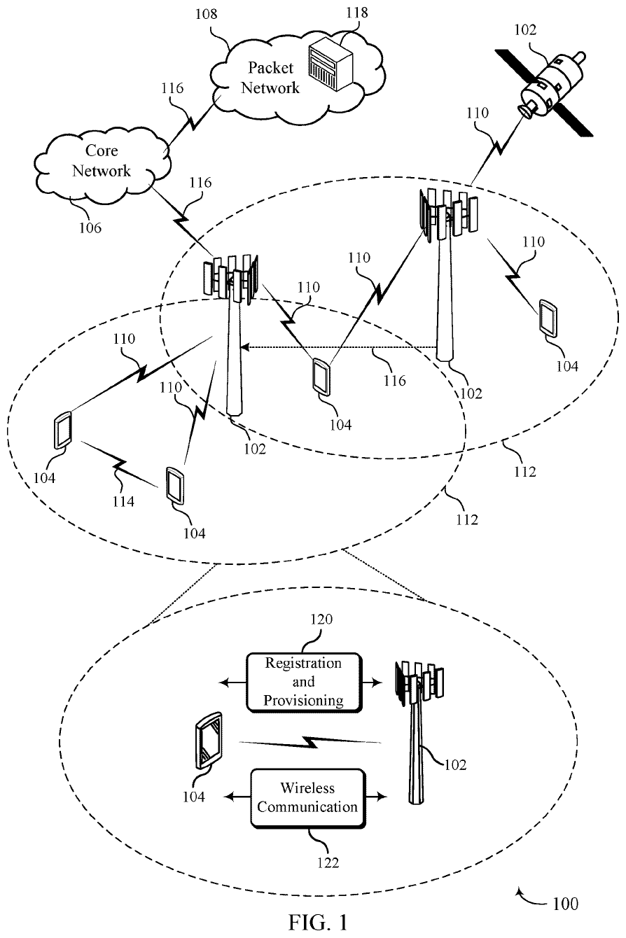

FIG. 1 illustrates an example of a wireless communications system 100 that supports UE association with a network in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=³) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for UE association with a network, a UE 104 and a network entity 102 can implement registration and provisioning 120 to register the UE 104 with a wireless network and to provision policies for the UE 104. Example ways for implementing the registration and provisioning 120 are discussed in detail throughout this disclosure. Accordingly, based at least in part on the registration and provisioning 120, the UE 104 can perform wireless communication 122 (e.g., wireless transmission and reception) with the network entity 102.

In some wireless communications systems (e.g., as described in 3GPP Technical Specification (TS) 24.501), a UE may include more than one payload in a Payload container information element (IE) by using the Payload container type IE with the value set to “Multiple payload.” This mechanism can be used during the registration by including the Payload container IE with multiple payloads as the payload container of the REGISTER REQUEST message.

According to 3GPP TS 29.525 [4]:
the UE STATE INDICATION message transmitted to the AMF within the REGISTER REQUEST message; and
the UE POLICY PROVISIONING REQUEST message transmitted to the AMF within the uplink (UL) NAS REQUEST message,
   are transferred transparently by the AMF to the PCF, within the “uePolReq” attribute of the PolicyAssociationRequest data structure in order to create the UE policy association with the PCF. For that the AMF can send an HTTP POST request with “{apiRoot}/npcf-ue-policy-control/v1/policies” as Resource Uniform Resource Identifier (URI) and the PolicyAssociationRequest data structure as a request body. As a response the AMF may receive an indication that the policy association is either created or not.

Accordingly, solutions are provided in this disclosure to support UE association with a network. For instance, in at least some implementations AMF behaviors are implemented as described in clause 5.4.5.2.3 of 3GPP TS 24.501 [1] for TRANSPORT message when the Payload container type is set to the value “Multiple payloads” and two separate HTTP POST request messages; each including a “uePolReq” attribute of the PolicyAssociationRequest data structure with either of the received UE STATE INDICATION message and the UE POLICY PROVISIONING REQUEST message. Further, in implementations an AMF combines information elements of the received UE STATE INDICATION message and the UE POLICY PROVISIONING REQUEST message within the same “uePolReq” attribute of the PolicyAssociationRequest data structure of the body of the HTTP POST request message.

In implementations, certain AMF behaviors are implemented as described in clause 5.4.5.2.3 of 3GPP TS 24.501 [1] for UL NAS TRANSPORT message when a Payload container type is set to the value “Multiple payloads,” with the AMF applying such behaviors on a REGISTER REQUEST message. The AMF, for instance, can create two separate HTTP POST request messages: one containing a UE STATE INDICATION message and the other containing a UE POLICY PROVISIONING REQUEST message, and transmit the request messages towards the PCF. The PCF can then create a UE policy association using both the UE STATE INDICATION message and the UE POLICY PROVISIONING REQUEST message. Accordingly, the PCF can implement a timer to ensure that it receives both messages before creating the UE policy association. Implementations may enable the PCF to be aware that there is more than one HTTP POST request message to be received before initiating the UE policy association. The following describes some example ways for providing such information.

According to implementations, there are several ways for a UE to indicate to a PCF a number of messages it should expect in order to create the UE policy association. One way is by a new information element such as UE policy message information element which indicates the existence and the number of messages which are to be used for UE policy association creation by the PCF. The UE policy message information element may be a type 3 information element with a length of 2 octets as described in Figure A and Table 1.

FIGURE A: UE policy message information element

| | | | | | | | |
|---|---|---|---|---|---|---|---|
| 8 | 7 | 6 | 5 | 4 | 3 | 2 | 1 |

| | |
|---|---|
| UE policy message IE | octet 1 |
| Number of UE policy messages | octet 2 |

TABLE 1
UE policy message information element

Number of UE policy messages (octet 2)
The field is coded as the number of UE policy messages which
are to be used by the PCF for creating the UE policy association.

While this example illustrates the number of messages as two, implementations may utilize more than two messages.

Another implementation is to assign a set of values for PTI (such as defined in 3GPP TS 24.501) to identify to the PCF that for example the UE STATE INDICATION message is not the only message which is to be used to create the UE policy association. The set of the PTI values can be chosen to indicate the number of the messages that the PCF is to expect in order to create the UE policy association.

The AMF may indicate to the PCF of the presence of more than one message and also the number of messages by adding an optional attribute with an attribute name such as “noUePolicyMsg” which includes the number of the message receive in the “uePolReq” attribute and the number of messages which are to be used by the PCF to create the UE Policy association. The data type for “noUePolicyMsg” may be “UePolicyMessage” and can be added to the PolicyAssociationRequest data type in Table 5.6.6.2.2-1 in 3GPP TS 29.525 [4], where the definition of the UePolicyMessage data type is added in Table 5.6.3.2-1 in 3GPP TS 29.525 [4] as:

| | | | |
|---|---|---|---|
| | Type | | |
| Type Name | Definition | Description | Applicability |

| | | |
|---|---|---|
| UePolicyMessage | Bytes | The message number included in |
| | | “uePolReq” attribute and the number |
| | | of messages which are to be used by |
| | | the PCF to create the UE policy |
| | | association. |

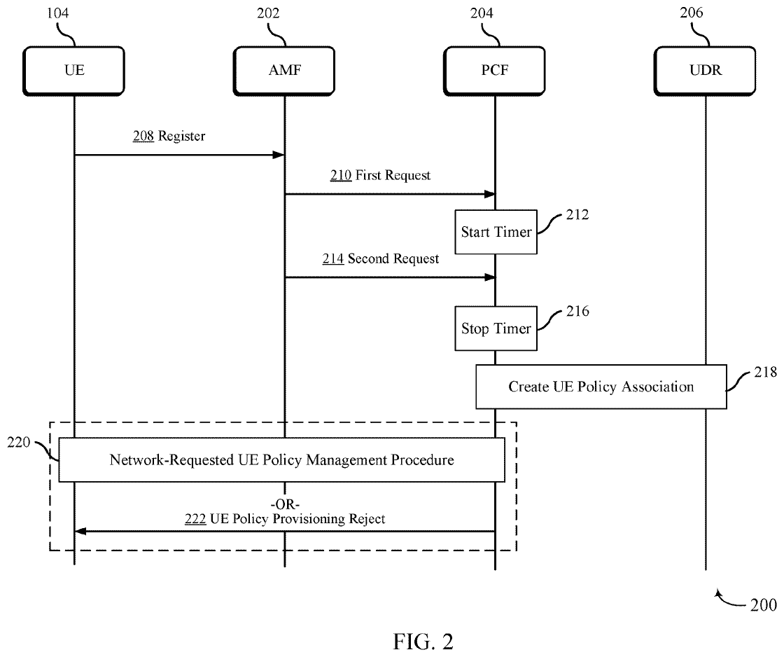

FIG. 2 illustrates an example system 200 that supports UE association with a network in accordance with aspects of the present disclosure. In the system 200, for instance, a UE STATE INDICATION message and a UE POLICY PROVISIONING REQUEST message are used to create the same UE policy association. The system 200 includes a UE 104, an AMF 202, a PCF 204, and a UDR 206.

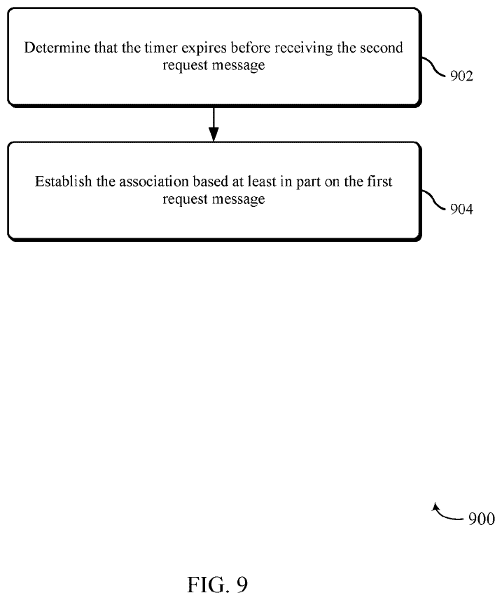

At 208 the UE 104 transmits to the network a REGISTER REQUEST message including:
a) Payload container type IE set to the value of “Multiple payload”; and
b) Payload container IE with the payload container contents according to FIG. 9.11.3.39.2 in 3GPP TS 24.501 [1] which comprises two entries:
   i) one entry with payload container type set to the value “UE policy container” and payload container entry contents comprising the UE STATE INDICATION message with the content:

| | | | | |
|---|---|---|---|---|
| PTI | Procedure transaction | M | V | 1 |
| | identity Clause 9.6 in | | | |
| | TS 24.501 | | | |
| UE STATE | UE policy delivery service | M | V | 1 |
| INDICATION | message type | | | |
| message identity | Clause D.6.1 in TS 24.501 | | | |
| UPSI list | UPSI list | M | LV-E | 9-65531 |
| | Clause D.6.4 in TS 24.501 | | | |
| UE policy | UE policy classmark | M | LV | 2-4 |
| classmark | Clause D.6.5 in TS 24.501 | | | |
| UE OS Id | OS Id | O | TLV | 18-242 |
| | Clause D.6.6 in TS 24.501 | | | |

ii) and the other entry with payload container type set to the value “UE policy container” and payload entry contents comprising the UE POLICY PROVISIONING REQUEST message with the content:

| | | | | |
|---|---|---|---|---|
| PTI | Procedure transaction identity | M | V | 1 |
| | Clause 9.6 in TS 24.501 | | | |
| UE POLICY | UE policy delivery service | M | V | 1 |
| PROVISIONING | message type | | | |
| REQUEST | Clause D.6.1 in TS 24.501 | | | |
| message identity | | | | |
| Requested UE | Requested UE policies | M | LV | 2-3 |
| policies | Clause 8.3.2 in TS 24.587 | | | |

The AMF 202 can then decode the content of the Payload container IE according to clause 9.11.3.39 in 3GPP TS 24.501 [1] to obtain the number of payload container entries which is two in this implementation: one containing the UE STATE INDICATION message and the other comprising the UE POLICY PROVISIONING REQUEST message. The AMF 202 for each payload container entry can:
a) decode the payload container type field which is “UE policy container” for both Payload container type fields in this context; and
b) handle the content of each payload container entry the same as the content of the Payload container IE and the associated optional IEs as specified according to the payload container type field when it is “UE policy container”

The AMF 202 then sends to the PCF 204 two HTTP POST requests (First HTTP POST request and Second HTTP POST request) with “{apiRoot}/npcf-ue-policy-control/v1/policies” as Resource URI and the PolicyAssociationRequest data structure as request body comprising:
a) one with the UE STATE INDICATION message with the content:

| | | | | |
|---|---|---|---|---|
| PTI | Procedure transaction | M | V | 1 |
| | identity Clause 9.6 in | | | |
| | TS 24.501 | | | |
| UE STATE | UE policy delivery service | M | V | 1 |
| INDICATION | message type | | | |
| message identity | Clause D.6.1 in TS 24.501 | | | |
| UPSI list | UPSI list | M | LV-E | 9-65531 |
| | Clause D.6.4 in TS 24.501 | | | |
| UE policy | UE policy classmark | M | LV | 2-4 |
| classmark | Clause D.6.5 in TS 24.501 | | | |
| UE OS Id | OS Id | O | TLV | 18-242 |
| | Clause D.6.6 in TS 24.501 | | | |

b) and the other with the UE POLICY PROVISIONING REQUEST message with the content:

| | | | | |
|---|---|---|---|---|
| PTI | Procedure transaction | M | V | 1 |
| | identity Clause 9.6 in | | | |
| | TS 24.501 | | | |
| UE POLICY | UE policy delivery service | M | V | 1 |
| PROVISIONING | message type | | | |
| REQUEST | Clause D.6.1 in TS 24.501 | | | |
| message identity | | | | |
| Requested UE | Requested UE policies | M | LV | 2-3 |
| policies | Clause 8.3.2 in TS 24.587 | | | |

At 210 the PCF 204 receives First HTTP POST request including:
a) either the UE STATE INDICATION message containing the information elements for UPSI list, UE policy classmark and UE's supporting OS IDs; or
b) the UE POLICY PROVISIONING REQUEST message comprising the Requested UE policies.

At 212 the PCF 204 starts a timer and at 214 the PCF 204 receives Second HTTP POST request comprising the other message which was not received at 210 in the First HTTP POST request policies during or after creating the UE policy association requested by the AMF 202. If the First HTTP POST request includes the UE STATE INDICATION message, the Second HTTP POST message includes the UE POLICY PROVISIONING REQUEST message, and vice versa.

At 216 the PCF 204 stops the timer and at 218 the PCF 204 uses the information elements received in UE STATE INDICATION message, the UE POLICY PROVISIONING REQUEST message and other attributes in the PolicyAssociationRequest data (see Table 5.6.2.3-1 in 3GPP TS 29.525 [4]) to create the UE policy association as requested by AMF by:
a) locating predefined policy sections;
b) retrieving policy sections from the UDR as specified in 3GPP TS 29.519 [5]; or
c) dynamically generating policy sections.

The policy sections can include UE Route Selection Policy (URSP) rule(s), Wireless Location Area Network Selection Policy (WLANSP) rule(s), N3AN node configuration information, requested policy such as V2XP and/or ProSeP information content. The PCF 204 may store the data received in the UE STATE INDICATION message, e.g., UPSCs and related policy sections of the Public Land Mobile Network (PLMN) or Standalone Non-Public Network (SNPN), UE's supported OS IDs, and UE support for ANDSP together with the Permanent Equipment Identifier (PEI) received from the AMF as pei attribute in the PolicyAssociationRequest data of the HTTP POST request. The PCF 204 may retrieve information indicating that new UE policy sections are to be installed from the UDR 206 such as due to current information from the UE, e.g., UPSIs, ANDSP support and/or supporting OS IDs. The PCF 204 may also receive information to make the URSP rules for the UE 104.

For the request carried by the Requested UE policies IE within the UE POLICY PROVISIONING REQUEST message, the PCF 204 may provision the policy based on the service specific parameter information retrieved from UE's application data in the UDR 206.

If the PCF 204 is to take action due to the update of the UE policy sections and/or provisioning the requested UE policies, at 220 the PCF 204 can initiate the network-requested UE policy management procedure as defined in 3GPP TS 24.501 [1]. If the PCF 204 does not need to take action due to the update of the UE policy sections, at 222 the PCF 204 can reject the request for the requested UE policies provisioning such as indicated for the V2X policy provisioning and/or ProSe policy provisioning is in clause 7.2.2 of 3GPP TS 24.587 [2].

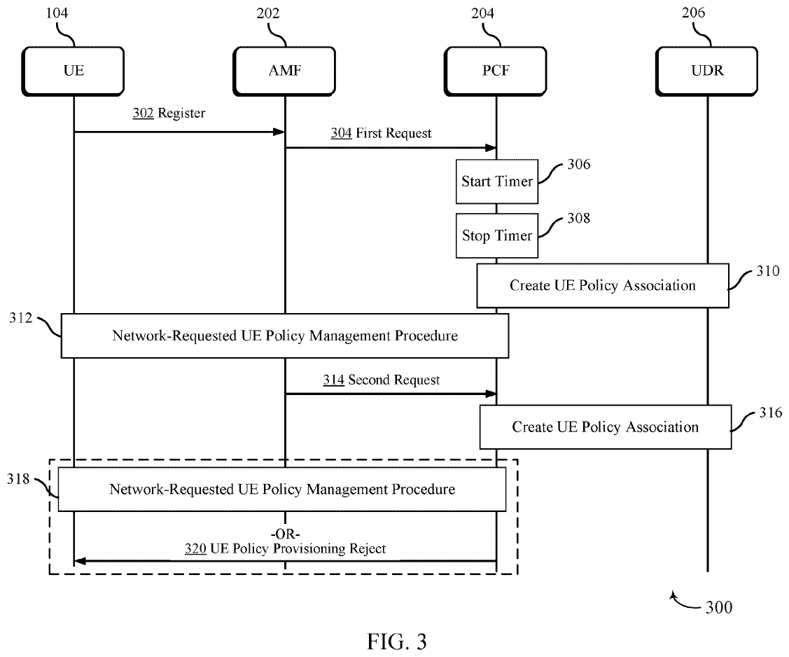

FIG. 3 illustrates an example system 300 that supports UE association with a network in accordance with aspects of the present disclosure. In the system 300, for instance, the UE POLICY PROVISIONING REQUEST message is received after the timer has expired and the UE STATE INDICATION message and the UE POLICY PROVISIONING REQUEST message (in that order) are used to create two separate UE policy association.

At 302 the UE 104 transmits to the network a REGISTER REQUEST message such as described above with reference to 208 of the system 200. At 304 the PCF 204 receives First HTTP POST request including the UE STATE INDICATION message containing the information elements for UPSI list, UE policy classmark and UE's supporting OS IDs. At 306 the PCF 204 starts a timer and at 308 the timer expires.

At 310 the PCF 204 uses the information elements received in UE STATE INDICATION message and other attributes in the PolicyAssociationRequest data (e.g., see Table 5.6.2.3-1 in 3GPP TS 29.525 [4]) to create the UE policy association as requested by AMF 202 by:
a) locating predefined policy sections;
b) retrieving policy sections from the UDR as specified in 3GPP TS 29.519 [5]; or
c) dynamically generating policy sections.

The policy sections can include URSP rule(s), WLANSP rule(s), N3AN node configuration information. The PCF 204 may store the data received in the UE STATE INDICATION message, e.g., UPSCs and related policy sections of the PLMN or SNPN, UE supported OS IDs, and UE support for ANDSP together with the PEI received from the AMF as pei attribute in the PolicyAssociationRequest data of First HTTP POST request. The PCF 204 may retrieve the information that new UE policy sections are to be installed from the UDR 206 due to the current information from the UE 104, e.g., UPSIs, ANDSP support and/or supporting OS IDs. The PCF 204 may also receive information to make the URSP rules for the UE 104.

If the PCF 204 is to take action due to the update of the UE policy sections, at 312 the PCF 204 initiates the network-requested UE policy management procedure such as defined in 3GPP TS 24.501 [1]. At 314 the PCF 204 receives Second HTTP POST request comprising the UE POLICY PROVISIONING REQUEST message containing the Request UE policies IE. In addition to UE policy association created at 310, at 316 new UE policy association can be created for the policy request carried by the Requested UE policies IE within the UE POLICY PROVISIONING REQUEST message. The PCF 204 may
a) locate predefined policy sections;
b) retrieve policy sections from the UDR 206 such as specified in 3GPP TS 29.519 [5]; or
c) dynamically generate policy sections,
   which can include requested policy such as V2XP and/or ProSeP info content. The PCF 204 may provision the policy based on the service specific parameter information retrieved from UE's application data in the UDR 206.

If the PCF 204 is to take action due to the provisioning the requested UE policies, at 318 the PCF 204 initiates the network-requested UE policy management procedure such as defined in 3GPP TS 24.501 [1]. If the PCF 204 does not need to take action due to the update of the UE policy sections, at 320 it rejects the request for the requested UE policies provisioning as shown for the V2X policy provisioning and/or ProSe policy provisioning, such as in clause 7.2.2 of 3GPP TS 24.587 [2].

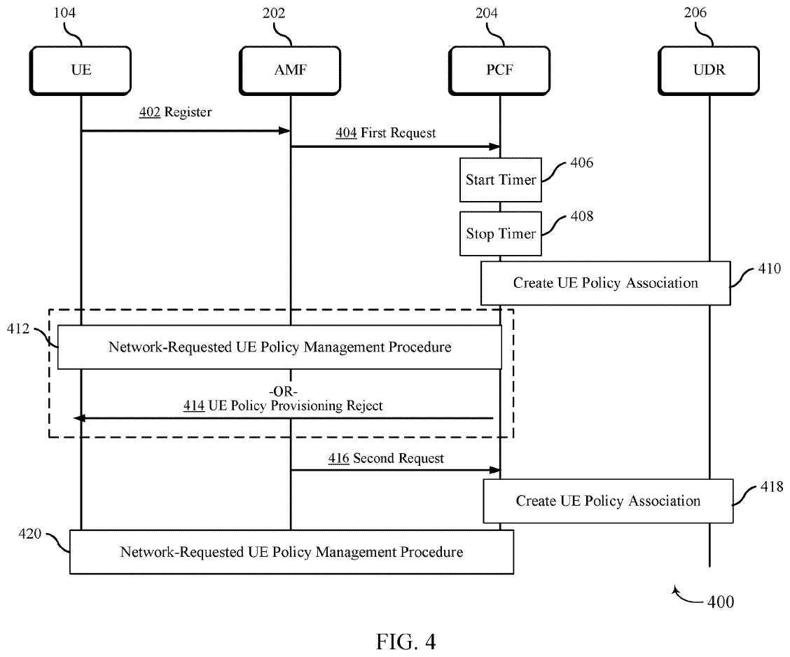

FIG. 4 illustrates an example system 400 that supports UE association with a network in accordance with aspects of the present disclosure. In the system 400, for instance, a UE STATE INDICATION message is received after the timer has been expired, and the UE POLICY PROVISIONING REQUEST message and the UE STATE INDICATION message (in that order) are used to create two separate UE policy associations. At 402 the UE 104 transmits to the network a REGISTER REQUEST message such as described above with reference to 208 of the system 200. At 404 the PCF 204 receives First HTTP POST request including the UE POLICY PROVISIONING REQUEST message containing the Request UE policies IE. At 406 the PCF 204 starts a timer and at 408 the timer expires.

The PCF 204 may store the PEI received from the AMF 202 as a pei attribute in the PolicyAssociationRequest data of First HTTP POST request. At 410 the PCF creates the UE policy association for the policy request carried by the Requested UE policies IE within the UE POLICY PROVISIONING REQUEST message. For that, the PCF 204 may use the PEI to retrieve the information about the UE policy sections and also UE's support for ANDSP and the UE's supporting OS IDs. The PCF 204 may:
a) locate predefined policy sections;
b) retrieve policy sections from the UDR such as specified in 3GPP TS 29.519 [2]; or
c) dynamically generate policy sections,
   which include requested policy such as V2XP and/or ProSeP info content. The PCF may provision the policy based on the service specific parameter information retrieved from UE's application data in the UDR and the information retrieved from the UDR.

If the PCF is to take action due to the provisioning the requested UE policies, at 412 the PCF initiates the network-requested UE policy management procedure such as defined in 3GPP TS 24.501 [1]. In implementations, upon receipt of the policy sections, the UE 104 may take into consideration whether it supports ANDSP and/or its supporting OS IDs to filter out the policies it cannot use.

If the PCF 204 does not need to take action due to the update of the UE policy sections, at 414 the PCF 204 can reject the request for the requested UE policies provisioning as shown for the V2X policy provisioning and/or ProSe policy provisioning such as in clause 7.2.2 of 3GPP TS 24.587 [2].

At 416 the PCF 204 receives Second HTTP POST request including the UE STATE INDICATION message containing the information elements for UPSI list, UE policy classmark and UE's supporting OS Ids. At 418 the PCF 204 uses the information elements received in UE STATE INDICATION message and other attributes in the PolicyAssociationRequest data (see Table 5.6.2.3-1 in 3GPP TS 29.525 [4]) to create the new UE policy association as requested by the AMF 202 by:
a) locating predefined policy sections;
b) retrieving policy sections from the UDR such as specified in 3GPP TS 29.519 [5]; or
c) dynamically generating policy sections.
   The policy sections comprise complete URSP rule(s), WLANSP rule(s), N3AN node configuration information.

The PCF 204 may store the data received in the UE STATE INDICATION message, e.g., UPSCs and related policy sections of the own PLMN or SNPN, UE supported OS IDs, and UE support for ANDSP together with the PEI received from the AMF as pei attribute in the PolicyAssociationRequest data of First HTTP POST request. The PCF 204 may retrieve information that new UE policy sections are to be installed from the UDR 206 due to the current information from the UE 104, e.g., UPSIs, ANDSP support and/or supporting OS IDs. The PCF 204 may also receive information to make the URSP rules for the UE 104.

If the PCF 204 is to take action due to the update of the UE policy sections, at 420 the PCF 204 initiates the network-requested UE policy management procedure such as defined in 3GPP TS 24.501 [1].

In additional or alternative implementations, the AMF behaves differently that what is described in clause 5.4.5.2.3 for UL NAS TRANSPORT message when the Payload container type is set to the value “Multiple payloads”. Since the UE STATE INDICATION message and the UE POLICY PROVISIONING REQUEST message can be combined into one message by the AMF, one HTTP POST request message can be used by the AMF and implementations may omit using a timer. The AMF may use the information elements of the received UE STATE INDICATION message and the UE POLICY PROVISIONING REQUEST message to create a unique payload, which contains
a) one PTI, one message identifier, UPSI list IE, UE policy classmark, UE OS Id and Requested UE policies IE; or
b) all information elements of UE STATE INDICATION message and UE POLICY PROVISIONING REQUEST message.

The AMF may include the payload in the “uePolReq” attribute of the PolicyAssociationRequest data structure of the HTTP POST request message such as defined in 3GPP TS 29.525 [4] and forward the HTTP POST request message toward the PCF.

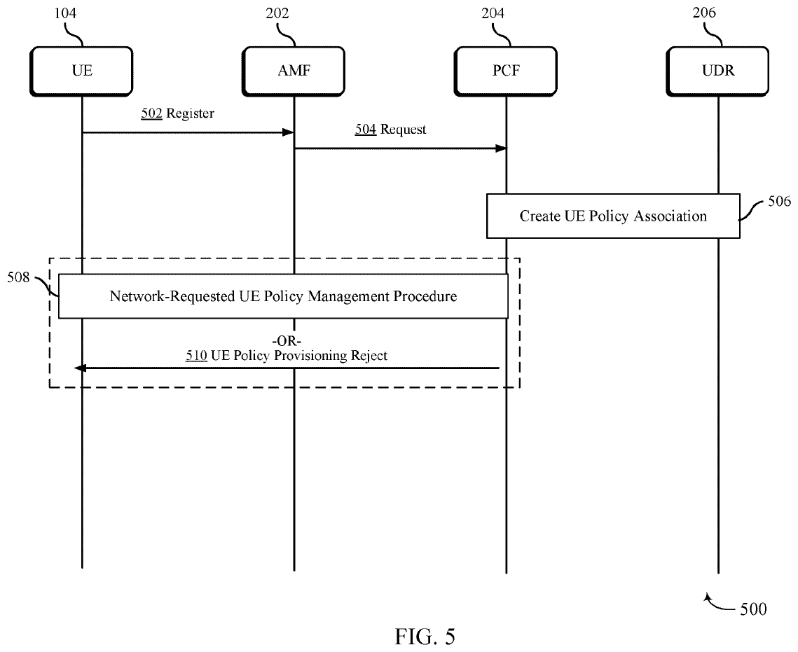

FIG. 5 illustrates an example system 500 that supports UE association with a network in accordance with aspects of the present disclosure. In the system 500, for instance, the AMF 202 combines the information elements from the UE STATE INDICATION message and the UE POLICY PROVISIONING REQUEST message to construct a payload with one PTI and one message identity.

At 502 the UE 104 transmits to the network a REGISTER REQUEST message including:
a) Payload container type IE set to the value of “Multiple payload”; and
b) Payload container IE with the payload container contents such as according to FIG. 9.11.3.39.2 in 3GPP TS 24.501 [1] which includes two entries:
   i) one entry with payload container type set to the value “UE policy container” and payload container entry contents comprising the UE STATE INDICATION message with the content:

| | | | | |
|---|---|---|---|---|
| PTI | Procedure transaction | M | V | 1 |
| | identity Clause 9.6 in | | | |
| | TS 24.501 | | | |
| UE STATE | UE policy delivery service | M | V | 1 |
| INDICATION | message type | | | |
| message identity | Clause D.6.1 in TS 24.501 | | | |
| UPSI list | UPSI list | M | LV-E | 9-65531 |
| | Clause D.6.4 in TS 24.501 | | | |
| UE policy | UE policy classmark | M | LV | 2-4 |
| classmark | Clause D.6.5 in TS 24.501 | | | |
| UE OS Id | OS Id | O | TLV | 18-242 |
| | Clause D.6.6 in TS 24.501 | | | |

ii) and the other entry with payload container type set to the value “UE policy container” and payload entry contents comprising the UE POLICY PROVISIONING REQUEST message with the content:

| | | | | |
|---|---|---|---|---|
| PTI | Procedure transaction identity | M | V | 1 |
| | Clause 9.6 in TS 24.501 | | | |
| UE POLICY | UE policy delivery service | M | V | 1 |
| PROVISIONING | message type | | | |
| REQUEST | Clause D.6.1 in TS 24.501 | | | |
| message identity | | | | |
| Requested UE | Requested UE policies | M | LV | 2-3 |
| policies | Clause 8.3.2 in TS 24.587 | | | |

The UE 104 may assign the same PTI to the UE STATE INDICATION message and the UE POLICY PROVISIONING REQUEST message.

Since the Payload container type IE is set to the value of “Multiple payloads” and each of the payload container entry has a payload container type set to “UE policy container”, the AMF 202 may include information elements from both the IEs from the UE STATE INDICATION message and the UE POLICY PROVISIONING REQUEST message in the same uePolReq by:
a) if PTIs are different in the received UE STATE INDICATION message and UE POLICY PROVISIONING REQUEST message, set to the same value such as the PTI value of the UE POLICY PROVISIONING REQUEST message since that is the message which should be responded to; and
b) having the same identity for the by removing one identity such as the UE POLICY PROVISIONING REQUEST message identity and keeping the other such as the UE STATE INDICATION message identity.

The contents of the uePolReq can be:

| | | | | |
|---|---|---|---|---|
| PTI | Procedure transaction | M | V | 1 |
| | identity 9.6 of TS 24.501 | | | |
| UE STATE | UE policy delivery service | M | V | 1 |
| INDICATION | message type | | | |
| message identity | D.6.1 of TS 24.501 | | | |
| UPSI list | UPSI list | M | LV-E | 9-65531 |
| | D.6.4 of TS 24.501 | | | |
| UE policy | UE policy classmark | M | LV | 2-4 |
| classmark | D.6.5 of TS 24.501 | | | |
| UE OS Id | OS Id | O | TLV | 18-242 |
| | D.6.6 of TS 24.501 | | | |
| Requested UE | Requested UE policies | M | LV | 2-3 |
| policies | 8.3.2 of TS 24.587 | | | |

At 504 the PCF 204 receives HTTP POST request comprising the uePolReq comprising the information elements for UPSI list, UE policy classmark, UE's supporting OS Ids and the Requested UE policies. At 506 the PCF 204 uses the information elements and other attributes in the PolicyAssociationRequest data (see, e.g., Table 5.6.2.3-1 in 3GPP TS 29.525 [4]) to create the UE policy association as requested by AMF by:
a) locating predefined policy sections;
b) retrieving policy sections from the UDR as specified in 3GPP TS 29.519 [5]; or
c) dynamically generating policy sections.
   The policy sections can include URSP rule(s), WLANSP rule(s), N3AN node configuration information, and requested policy such as V2XP and/or ProSeP information content.

The PCF 204 may store the data received in the UE STATE INDICATION message, e.g., UPSCs and related policy sections of the PLMN or SNPN, UE supported OS IDs, and UE support for ANDSP together with the PEI received from the AMF as pei attribute in the PolicyAssociationRequest data of the HTTP POST request. The PCF 204 may retrieve information that new UE policy sections are to be installed from the UDR 206 due to current information from the UE 104, e.g., UPSIs, ANDSP support and/or supporting OS IDs. The PCF 204 may also receive information to make the URSP rules for the UE 104.

For the request carried by the Requested UE policies IE within the UE POLICY PROVISIONING REQUEST message, the PCF 204 may provision the policy based on the service specific parameter information retrieved from UE's application data in the UDR 206.

If the PCF is to take action due to the update of the UE policy sections and/or provisioning the requested UE policies, at 508 the PCF 204 initiates the network-requested UE policy management procedure, such as defined in 3GPP TS 24.501 [1]. If the PCF 204 does not need to take action due to the update of the UE policy sections, at 510 the PCF 204 can reject the request for the requested UE policies provisioning as shown for the V2X policy provisioning and/or ProSe policy provisioning, such as in clause 7.2.2 of 3GPP TS 24.587 [2].

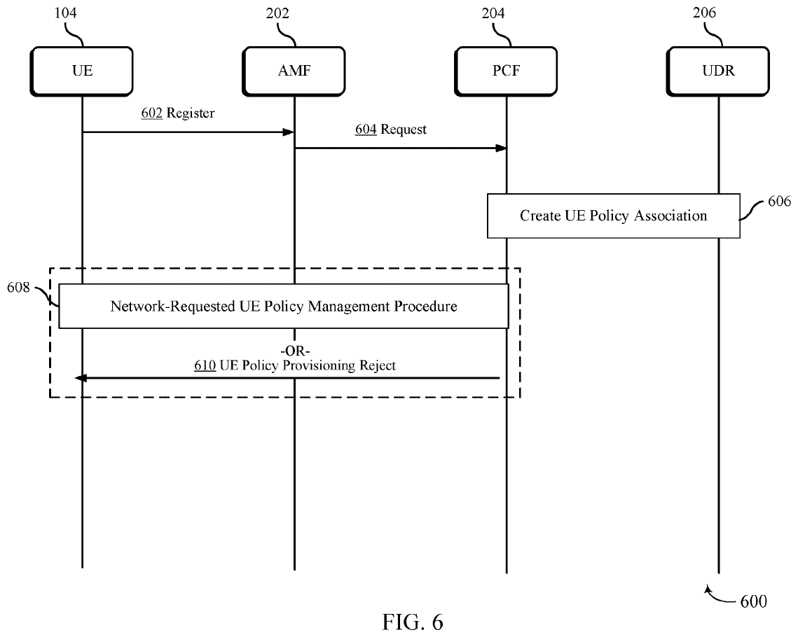

FIG. 6 illustrates an example system 600 that supports UE association with a network in accordance with aspects of the present disclosure. In the system 600, for instance, the AMF 202 combines the information elements from the UE STATE INDICATION message and the UE POLICY PROVISIONING REQUEST message to construct a payload with PTI, message identity, and information elements of the UE STATE INDICATION message and PTI, message identity and information elements of the UE POLICY PROVISIONING REQUEST message.

At 602 the UE 104 transmits to the network a REGISTER REQUEST message such as described above with reference to 502 of the system 500, except the UE 104 does not assign the same PTI to the UE STATE INDICATION message and the UE POLICY PROVISIONING REQUEST message.

At 604 the PCF 204 receives the HTTP POST request. Since the Payload container type IE is set to the value of “Multiple payloads” and each payload container entry has a payload container type set to “UE policy container”, the AMF 202 may include the payload container entry contents of both payload container entries which are the UE STATE INDICATION message and the UE POLICY PROVISIONING REQUEST message in the same uePolReq.

The contents of the uePolReq can include:

| | | | | |
|---|---|---|---|---|
| PTI for UE STATE | Procedure transaction | M | V | 1 |
| INDICATION | identity 9.6 of TS | | | |
| message | 24.501 | | | |
| UE STATE | UE policy delivery | M | V | 1 |
| INDICATION | service message type | | | |
| message identity | D.6.1 of TS 24.501 | | | |
| UPSI list | UPSI list | M | LV-E | 9-65531 |
| | D.6.4 of TS 24.501 | | | |
| UE policy | UE policy classmark | M | LV | 2-4 |
| classmark | D.6.5 of TS 24.501 | | | |
| UE OS Id | OS Id | O | TLV | 18-242 |
| | D.6.6 of TS 24.501 | | | |
| PTI for UE POLICY | Procedure transaction | M | V | 1 |
| PROVISIONING | identity Clause 9.6 in | | | |
| REQUEST message | TS 24.501 | | | |
| UE POLICY | UE policy delivery | M | V | 1 |
| PROVISIONING | service message type | | | |
| REQUEST | Clause D.6.1 in | | | |
| message identity | TS 24.501 | | | |
| Requested UE | Requested UE policies | M | LV | 2-3 |
| policies | 8.3.2 of TS 24.587 | | | |

As mentioned above, at 604 the PCF 204 receives HTTP POST request comprising the uePolReq comprising the part for the UE STATE INDICATION message with the information elements for UPSI list, UE policy classmark, UE's supporting OS IDs and the Requested UE policies. at 606 the PCF 204 uses the information elements and other attributes in the PolicyAssociationRequest data (see, e.g., Table 5.6.2.3-1 in 3GPP TS 29.525 [4]) to create the UE policy association as requested by AMF by:
a) locating predefined policy sections;
b) retrieving policy sections from the UDR such as specified in 3GPP TS 29.519 [5]; or
c) dynamically generating policy sections.
   The policy sections can include URSP rule(s), WLANSP rule(s), N3AN node configuration information, and requested policy such as V2XP and/or ProSeP information content.

The PCF 204 may store the data received in the UE STATE INDICATION message part of the uePolReq, e.g., UPSCs and related policy sections of the own PLMN or SNPN, UE's supporting OS IDs, and UE support for ANDSP together with the PEI received from the AMF as pei attribute in the PolicyAssociationRequest data of the HTTP POST request. The PCF 204 may retrieve the information that new UE policy sections are to be installed from the UDR 206 due to current information from the UE 104, e.g., UPSIs, ANDSP support and/or supporting OS Ids. The PCF 204 may also receive information to make the URSP rules for the UE 104.

For the request carried by the part for the UE POLICY PROVISIONING REQUEST message with the Requested UE policies IE, the PCF 204 may provision the policy based on the service specific parameter information retrieved from UE's application data in the UDR 206.

If the PCF 204 is to take action due to the update of the UE policy sections and/or provisioning the requested UE policies, at 608 the PCF 204 initiates the network-requested UE policy management procedure such as defined in 3GPP TS 24.501 [1] and uses PTI equal to the one for UE POLICY PROVISIONING REQUEST message.

If the PCF 204 does not need to take action due to the update of the UE policy sections, at 610 the PCF 204 rejects the request for the requested UE policies provisioning as shown for the V2X policy provisioning and/or ProSe policy provisioning, such as specified in clause 7.2.2 of 3GPP TS 24.587 [2].

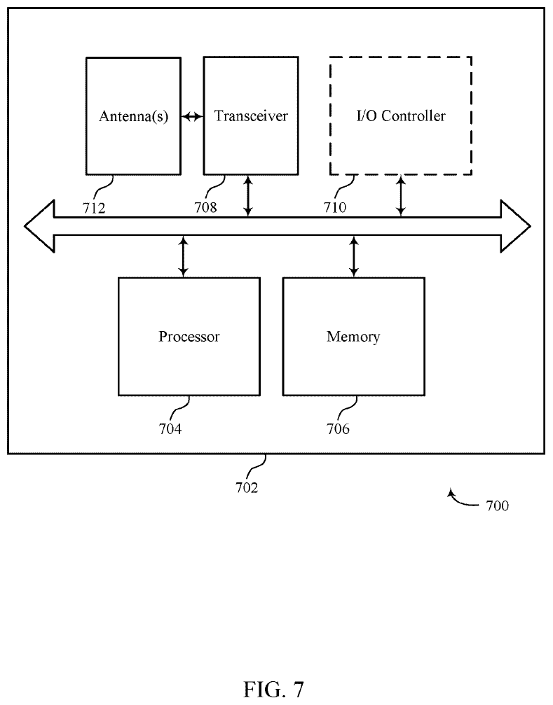

FIG. 7 illustrates an example of a block diagram 700 of a device 702 (e.g., an apparatus) that supports UE association with a network in accordance with aspects of the present disclosure. The device 702 may be an example of a network entity 102 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of network entity 102, for example, the transceiver 708 and the processor 704 coupled to the transceiver 708 are configured to cause the network entity 102 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as or otherwise support a means to receive a first request message to create an association, the first request including at least a first payload; initiate, based at least in part on the first request message, a timer; receive a second request message to create the association, the second request message including at least a second payload not included in the first request message; stop, based at least in part on the second request message, the timer; and establish, based at least in part on the first request message and the second request message, the association.

Further, in some implementations, the first payload includes state information for a UE; the state information includes: one or more policy sections; support for ANDSP; and optionally, one or more supported OS IDs; the second payload includes a request for policy provisioning for one or more services; the processor is further configured to: determine that the timer expires before receiving the second request message; and establish the association based at least in part on the first request message; the association includes a UE policy association; to establish the UE policy association, the processor is configured to implement one or more of to: locate one or more predefined policy sections; retrieve one or more policy sections from a UDR where the one or more policy sections are associated with the UE; or dynamically generate one or more policy sections; one or more of the first request message or the second request message includes an indicator of multiple requests and a number of requests, the indicator further indicating that the first request message and the second request message are configured for establishing the association; the apparatus is associated with a PCF of a network, the first request and the second request are received from an AMF of the network, and the processor is further configured to establish the association via interaction with a UDR of the network; the processor is configured to receive the first request message via a first HTTP POST request and receive the second request message as a second HTTP POST request.

In a further example, the processor 704 and/or the transceiver 708 may support wireless communication at the device 702 in accordance with examples as disclosed herein. The processor 704 and/or the transceiver 708, for instance, may be configured as or otherwise support a means to receive a first request message to create an association, the first request message including at least a first payload; initiate, based at least in part on the first request message, a timer; stop the timer; establish, based at least in part on the first request message, a first association; receive a second request message to create the association, the second request including at least a second payload not included in the first request; and establish, based on both the first request message and the second request message, the association.

Further, in some implementations, the first payload includes state information for a UE; the state information includes: one or more policy sections; support for ANDSP; and optionally, one or more supported OS IDs; the second payload includes a request for policy provisioning for one or more services; the first association and the association include a UE policy association; one or more of the first request message or the second request message includes an indicator of multiple requests and a number of requests, the indicator further indicating that the first request message and the second request message are configured for establishing the association; to establish one or more of the first association or the association, the processor is configured to implement one or more of to: locate one or more predefined policy sections; retrieve one or more policy sections from a UDR where the one or more policy sections are associated with a UE; or dynamically generate one or more policy sections; the processor is configured to receive the first request message via a first HTTP POST request and receive the second request message as a second HTTP POST request.

In a further example, the processor 704 and/or the transceiver 708 may support wireless communication at the device 702 in accordance with examples as disclosed herein. The processor 704 and/or the transceiver 708, for instance, may be configured as or otherwise support a means to receive, from a UE, a register message for creating an association, the register message including state information for the UE and a request for policy provisioning for one or more services for the UE; transmit a request message including the state information and the request for policy provisioning; and implement, based at least in part on the request message, a policy provisioning procedure to create the association.

Further, in some implementations, the state information for the UE includes: one or more policy sections; support for ANDSP; and optionally, one or more supported OS IDs; the first apparatus is associated with an AMF of a network, and wherein the processor is configured to transmit the request message to a PCF of the network.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M06. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

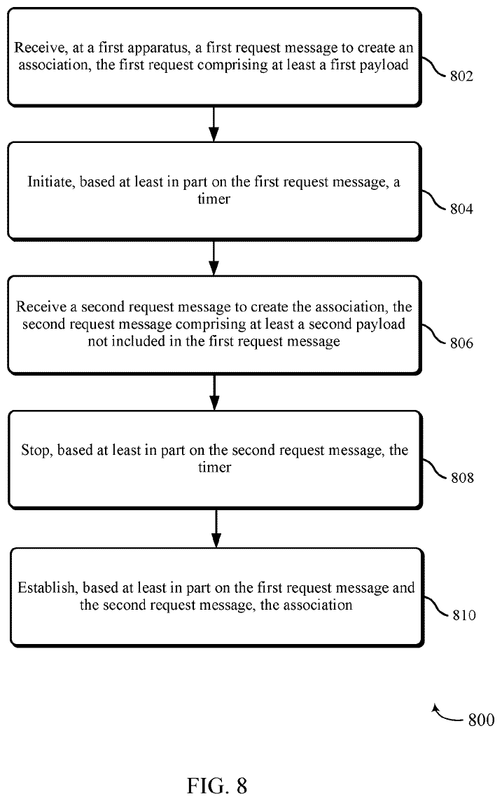

FIG. 8 illustrates a flowchart of a method 800 that supports UE association with a network in accordance with aspects of the present disclosure. The operations of the method 800 may be implemented by a device or its components as described herein. For example, the operations of the method 800 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving, at a first apparatus, a first request message to create an association, the first request comprising at least a first payload. The operations of 802 may be performed in accordance with examples as described herein. In some implementations, aspects of the operations of 802 may be performed by a device as described with reference to FIG. 1.

At 804, the method may include initiating, based at least in part on the first request message, a timer. The operations of 804 may be performed in accordance with examples as described herein. In some implementations, aspects of the operations of 804 may be performed by a device as described with reference to FIG. 1.

At 806, the method may include receiving a second request message to create the association, the second request message comprising at least a second payload not included in the first request message. The operations of 806 may be performed in accordance with examples as described herein. In some implementations, aspects of the operations of 806 may be performed by a device as described with reference to FIG. 1.

At 808, the method may include stopping, based at least in part on the second request message, the timer. The operations of 808 may be performed in accordance with examples as described herein. In some implementations, aspects of the operations of 808 may be performed by a device as described with reference to FIG. 1.

At 810, the method may include establishing, based at least in part on the first request message and the second request message, the association. The operations of 810 may be performed in accordance with examples as described herein. In some implementations, aspects of the operations of 810 may be performed by a device as described with reference to FIG. 1.

FIG. 9 illustrates a flowchart of a method 900 that supports UE association with a network in accordance with aspects of the present disclosure. The operations of the method 900 may be implemented by a device or its components as described herein. For example, the operations of the method 900 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include determining that the timer expires before receiving the second request message. The operations of 902 may be performed in accordance with examples as described herein. In some implementations, aspects of the operations of 902 may be performed by a device as described with reference to FIG. 1.

At 904, the method may include establishing the association based at least in part on the first request message. The operations of 904 may be performed in accordance with examples as described herein. In some implementations, aspects of the operations of 904 may be performed by a device as described with reference to FIG. 1.

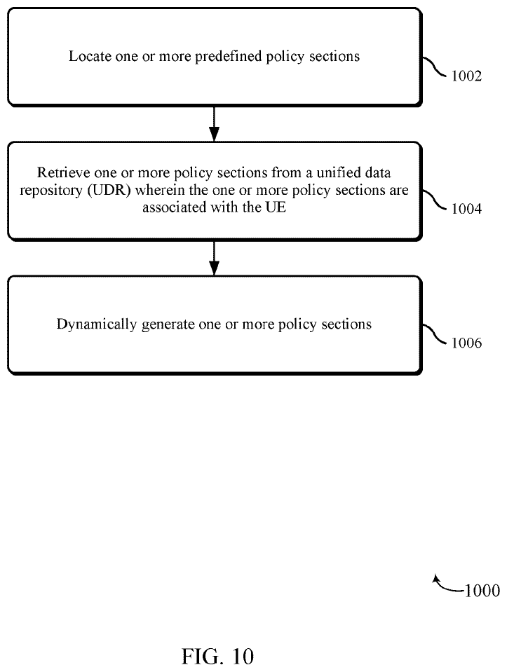

FIG. 10 illustrates a flowchart of a method 1000 that supports UE association with a network in accordance with aspects of the present disclosure. The operations of the method 1000 may be implemented by a device or its components as described herein. For example, the operations of the method 1000 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include locating one or more predefined policy sections. The operations of 1002 may be performed in accordance with examples as described herein. In some implementations, aspects of the operations of 1002 may be performed by a device as described with reference to FIG. 1.

At 1004, the method may include retrieving one or more policy sections from a UDR wherein the one or more policy sections are associated with the UE. The operations of 1004 may be performed in accordance with examples as described herein. In some implementations, aspects of the operations of 1004 may be performed by a device as described with reference to FIG. 1.

At 1006, the method may include dynamically generating one or more policy sections. The operations of 1006 may be performed in accordance with examples as described herein. In some implementations, aspects of the operations of 1006 may be performed by a device as described with reference to FIG. 1.

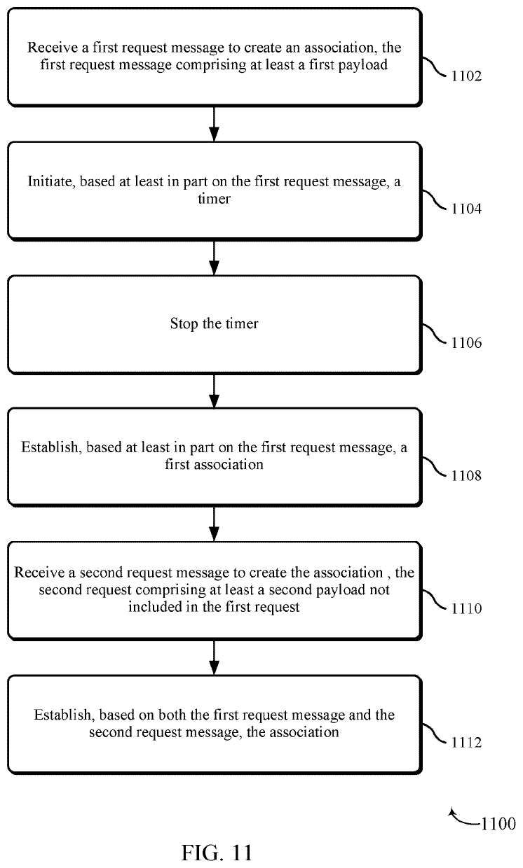

FIG. 11 illustrates a flowchart of a method 1100 that supports UE association with a network in accordance with aspects of the present disclosure. The operations of the method 1100 may be implemented by a device or its components as described herein. For example, the operations of the method 1100 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include receiving a first request message to create an association, the first request message comprising at least a first payload. The operations of 1102 may be performed in accordance with examples as described herein. In some implementations, aspects of the operations of 1102 may be performed by a device as described with reference to FIG. 1.

At 1104, the method may include initiating, based at least in part on the first request message, a timer. The operations of 1104 may be performed in accordance with examples as described herein. In some implementations, aspects of the operations of 1104 may be performed by a device as described with reference to FIG. 1.

At 1106, the method may include stopping the timer. The operations of 1106 may be performed in accordance with examples as described herein. In some implementations, aspects of the operations of 1106 may be performed by a device as described with reference to FIG. 1.

At 1108, the method may include establishing, based at least in part on the first request message, a first association. The operations of 1108 may be performed in accordance with examples as described herein. In some implementations, aspects of the operations of 1108 may be performed by a device as described with reference to FIG. 1.

At 1110, the method may include receiving a second request message to create the association, the second request comprising at least a second payload not included in the first request. The operations of 1110 may be performed in accordance with examples as described herein. In some implementations, aspects of the operations of 1110 may be performed by a device as described with reference to FIG. 1.

At 1112, the method may include establishing, based on both the first request message and the second request message, the association. The operations of 1112 may be performed in accordance with examples as described herein. In some implementations, aspects of the operations of 1112 may be performed by a device as described with reference to FIG. 1.

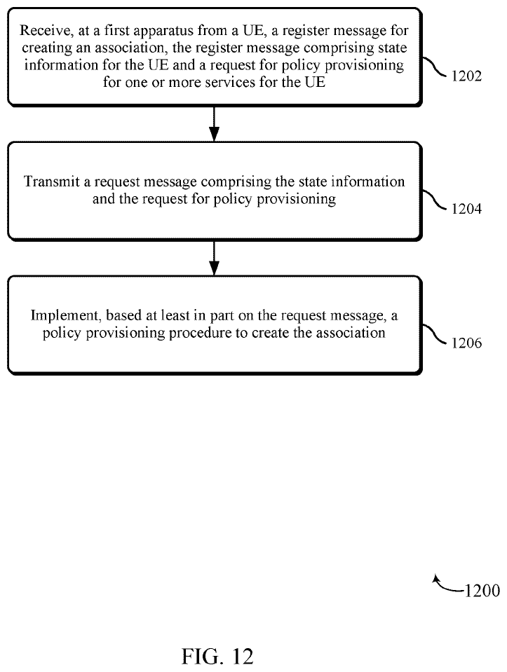

FIG. 12 illustrates a flowchart of a method 1200 that supports UE association with a network in accordance with aspects of the present disclosure. The operations of the method 1200 may be implemented by a device or its components as described herein. For example, the operations of the method 1200 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include receiving, at a first apparatus from a UE, a register message for creating an association, the register message comprising state information for the UE and a request for policy provisioning for one or more services for the UE. The operations of 1202 may be performed in accordance with examples as described herein. In some implementations, aspects of the operations of 1202 may be performed by a device as described with reference to FIG. 1.

At 1204, the method may include transmitting a request message comprising the state information and the request for policy provisioning. The operations of 1204 may be performed in accordance with examples as described herein. In some implementations, aspects of the operations of 1204 may be performed by a device as described with reference to FIG. 1.

At 1206, the method may include implementing, based at least in part on the request message, a policy provisioning procedure to create the association. The operations of 1206 may be performed in accordance with examples as described herein. In some implementations, aspects of the operations of 1206 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and operable to cause the network entity to:
receive a first request message to create an association, the first request message comprising at least a first payload;
initiate, based at least in part on the first request message, a timer;
receive a second request message to create the association, the second request message comprising at least a second payload not included in the first request message;
stop, based at least in part on the second request message, the timer; and
establish, based at least in part on the first request message and the second request message, the association.

2. The network entity of claim 1, wherein the first payload comprises state information for a user equipment (UE).

3. The network entity of claim 2, wherein the state information comprises one or more of:
one or more policy sections;
support for access network discovery and selection policy (ANDSP); or
one or more supported OS IDs.

4. The network entity of claim 1, wherein the second payload comprises a request for policy provisioning for one or more services.

5. The network entity of claim 1, wherein the at least one processor is operable to cause the network entity to:
determine that the timer expires before receiving the second request message; and
establish the association based at least in part on the first request message.

6. The network entity of claim 1, wherein the association comprises a user equipment (UE) policy association.

7. The network entity of claim 6, wherein to establish the UE policy association, the at least one processor is operable to cause the network entity to one or more of:
locate one or more predefined policy sections;
retrieve one or more policy sections from a unified data repository (UDR) wherein the one or more policy sections are associated with a user equipment (UE); or
dynamically generate one or more policy sections.

8. The network entity of claim 1, wherein one or more of the first request message or the second request message comprises an indicator of multiple requests and a number of requests, the indicator further indicating that the first request message and the second request message are configured for establishing the association.

9. The network entity of claim 1, wherein network entity is associated with a policy control function (PCF) of a network, the first request message and the second request message are received from an access and mobility management function (AMF) of the network, and the at least one processor is operable to cause the network entity to establish the association via interaction with a UDR of the network.

10. The network entity of claim 1, wherein the at least one processor is operable to cause the network entity to receive the first request message via a first hypertext transfer protocol (HTTP) POST request and receive the second request message as a second HTTP POST request.

11. A network entity comprising:
at least one memory; and
at least one processor coupled with the at least one memory and operable to cause the network entity to:
receive a first request message to create an association, the first request message comprising at least a first payload;
initiate, based at least in part on the first request message, a timer;
stop the timer;
establish, based at least in part on the first request message, a first association;
receive a second request message to create the association, the second request message comprising at least a second payload not included in the first request message; and
establish, based on both the first request message and the second request message, the association.

12. The network entity of claim 11, wherein the first payload comprises state information for a user equipment (UE).

13. The network entity of claim 12, wherein the state information comprises one or more of:
one or more policy sections;
support for access network discovery and selection policy (ANDSP); or
one or more supported OS IDs.

14. The network entity of claim 11, wherein the second payload comprises a request for policy provisioning for one or more services.

15. The network entity of claim 11, wherein the first association and the association comprise a user equipment (UE) policy association.

16. The network entity of claim 11, wherein one or more of the first request message or the second request message comprises an indicator of multiple requests and a number of requests, the indicator further indicating that the first request message and the second request message are configured for establishing the association.

17. The network entity of claim 11, wherein to establish one or more of the first association or the association, the at least one processor is operable to cause the network entity to one or more of:
locate one or more predefined policy sections;
retrieve one or more policy sections from a unified data repository (UDR) wherein the one or more policy sections are associated with a user equipment (UE); or
dynamically generate one or more policy sections.

18. The network entity of claim 11, wherein the at least one processor is operable to cause the network entity to receive the first request message via a first hypertext transfer protocol (HTTP) POST request and receive the second request message as a second HTTP POST request.

19. A network entity comprising:
at least one memory; and
at least one processor coupled with the at least one memory and operable to cause the network entity to:
receive, from a user equipment (UE), a register message for creating an association, the register message comprising state information for the UE and a request for policy provisioning for one or more services for the UE;
transmit a request message comprising the state information and the request for policy provisioning; and
implement, based at least in part on the request message, a policy provisioning procedure to create the association.

20. A method performed by a network entity, the method comprising:
receiving, at the network entity, a first request message to create an association, the first request message comprising at least a first payload;
initiating, based at least in part on the first request message, a timer;
receiving a second request message to create the association, the second request message comprising at least a second payload not included in the first request message;
stopping, based at least in part on the second request message, the timer; and
establishing, based at least in part on the first request message and the second request message, the association.
